(19) United States
(12) Patent Application Publication
(10) Pub. No.: US 2006/0086415 A1
(43) Pub. Date: Apr. 27, 2006

(54) Support means and elevator for transporting a load by a support means

(76) Inventor: Roland Eichhorn, Oberkulm (CH)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/259,381

(22) Filed: Oct. 26, 2005

(30) Foreign Application Priority Data
Oct. 26, 2004 (EP) 04105275.4

(51) Int. Cl. A01G 23/095; B27M 3/00

(52) U.S. Cl. 144/24.13

(57) ABSTRACT

A support cable has a trunk including at least one strand consisting of several tensile carriers twisted or braided together and which extends in a longitudinal direction of the cable with a cross-sectional area having a width to height ratio of preferably 0.5 to 2. Fastened to the trunk is at least one guide body extending in the longitudinal direction of the cable and projecting laterally from the trunk. In a load transporting elevator, the cable is connected with the respective load and is movable in its longitudinal direction, wherein the trunk of the support cable is brought into contact with at least one guide surface for the trunk so as to guide the cable transversely to the longitudinal direction thereof. The elevator has at least one guide device for the respective guide body for limiting or preventing a rotation of the cable about the longitudinal direction thereof.

### BACKGROUND OF THE INVENTION

The present invention relates to a support means and to an elevator for transporting at least one load by such a support means.

Support means used in an elevator for transporting loads usually have a trunk or body which comprises at least one strand, which consists of several tensile carriers twisted or braided together and which extends in the longitudinal direction of the support means. The support means are usually connected with the respective loads and arranged in such a manner that they are movable in their longitudinal direction. In order to be able to move the support means in a controlled manner the support means are usually guided transversely to their longitudinal direction. For this purpose the trunks of the support means are usually brought into contact with suitably arranged guide surfaces. In elevators the support means are usually guided at guide surfaces arranged at the periphery of pulleys (for example a drive pulley) or rollers (for example a deflecting roller). For optimization of the guidance the possibility exists of matching the respective support means and the guide surfaces, which are provided for guidance of the support means, to one another, for example with respect to their shaping and the respective materials.

An elevator for conveying at least one load by a support means, which is connected with the load and movable in its longitudinal direction, in the form of a cable is, for example, shown in European patent document EP 0672781 A1. The cable consists of synthetic material strands, which are twisted in several layers to form a single strand extending in the longitudinal direction of the cable, and a casing surrounding the strand. The cable in the unloaded state has a cross-section with a circularly round profile. The cable in the case of movement in its longitudinal direction is guided each time transversely to its longitudinal direction. For this purpose the cable is guided in guide grooves formed at the periphery of a drive pulley or at the periphery of rollers. The guide grooves have (in a cross-section), for example, a half-round shape. In an alternative it is taken into consideration that the cable can be deformed in the guide grooves, under loading, in each instance by pressing forces and its cross-section can, due to the deformation, adopt an oval shape. The cable accordingly has a cross-sectional area with a width “A” and a height “B” with a ratio A/B equal to “1” in the unloaded state or close to “1” in a loaded state. Accordingly, it is provided that the cross-section of the guide grooves can also have an oval shape. The shape of the cross-section of the respective guide groove is adapted to the shape of the cross-section of the cable in such a manner that the cable not only rests on the base of the guide groove, but is also disposed in contact with the flanks of the guide groove. The cable can be guided in guide grooves of that kind, in the case of a movement in its longitudinal direction, with a high degree of stability transversely to its longitudinal direction, particularly when the cable rests on the base of the respective guide groove. However, the possibility exists that the cable rotates in the guide grooves about its longitudinal axis, for example under the influence of torsional moments which can be introduced into the cable (in certain circumstances in the case of circulation of the cable around the drive pulley or around the rollers), or under the influence of torsional moments which can be induced in the cable itself (for example, when the synthetic fiber strands forming the strand are so twisted together that the strand is not free of rotation under tensile load). This can be problematic, since the cable under the influence of torsional moments twists at least in individual length sections and can be damaged in the case of excessive twistings.

PCT publication WO 99/43589 shows an elevator in which a flat belt is used as a support means for transporting loads. The belt comprises several strands, which consist of tensile carriers twisted together and which extend in the longitudinal direction of the support means and are arranged parallel to one another, and a casing surrounding the strands. The belt has a rectangular cross-section, the profile of which has a width “A” and a height “B” with a ratio A/B greater than “1”. The belt is guided transversely to its longitudinal direction each time in guide grooves which are formed at the periphery of the drive pulley or the periphery of rollers and have a rectangular cross-section. The belt in that case is so arranged that it rests by its wide side each time on the base of the respective guide groove. A preferred form of embodiment of this belt has a cross-section for which the ratio A/B is substantially greater than “1”, for example A/B greater than “4”. In this case the belt is substantially wider than high. A belt which is substantially wider than high is as a rule guided transversely to its longitudinal direction in a guide groove—when it rests by its wide side on a guide surface and is disposed under a tensile load—in such a manner that it cannot rotate in its longitudinal direction. However, the guidance of a belt of that kind is made difficult in that in the case of circulation of the belt around the drive pulley or around the rollers relatively strong disturbing forces can arise which occur in fluctuating manner and act on the belt transversely to the longitudinal direction thereof and parallel to the wide side of the belt. Disturbing forces of that kind have a destabilizing effect with respect to the guidance of the belt and can cause the belt to execute, in a guide groove, a fluctuating lateral movement in direction towards the flanks of the guide groove. The belt can in this manner be repeatedly pressed in the guide grooves against the flanks of the guide grooves and in that case deformed. In this manner wear of the belt can be drastically amplified. The belt can, under the influence of the disturbing forces, in certain circumstances migrate over the flanks of a guide groove and leave the guide groove. Accordingly, it can be a problem to keep the belt reliably in the respective guide grooves.

### SUMMARY OF THE INVENTION

An object of the present invention resides in avoiding the stated disadvantages and in making available a support means and an elevator for transporting at least one load by a support means of that kind in such a manner that the support means can be reliably guided transversely to its longitudinal direction and an excessive twisting of the support means about the longitudinal direction thereof can be avoided.

The support means according to the present invention has a trunk which comprises at least one strand consisting of several tensile carriers twisted or braided together and which extends in the longitudinal direction of the support means. According to the present invention at least one guide body is fastened to the trunk, which guide body extends in the longitudinal direction of the support means and projects laterally of the trunk.

The respective guide body can be so dimensioned that at the surface of the trunk near the guide body a region extending in the longitudinal direction of the trunk is available, which region can be brought into contact with suitable guide means so as to guide the support means transversely to the longitudinal direction in the case of movement in its longitudinal direction. Since the guide body is fastened to the trunk, the guide body in the case of rotation of the support means about the longitudinal direction thereof would similarly execute a rotational movement about the longitudinal direction of the support means. Due to the fact that the guide body projects laterally from the trunk and extends in the longitudinal direction of the support means, a rotational movement of that kind of the guide body can be kept within predetermined limits, or prevented, by a suitably arranged guide device. Since the guide body is fastened to the trunk of the support means, in this way a rotation of the support means about the longitudinal direction thereof can be kept within predetermined limits or prevented.

Accordingly, the support means can, for example, be used as follows in an elevator for transporting loads. The support means can be connected with the respective load and arranged in such a manner that it is movable in its longitudinal direction and the trunk in the support means is brought into contact with at least one guide surface for the trunk so as to guide the support means transversely to its longitudinal direction. The elevator can in addition comprise at least one guide device for the respective guide body for limiting or preventing rotation of the support means about the longitudinal axis thereof.

In an elevator of that kind, torsional moments, which in a given case act on the support means, can rotate or twist the support means merely within limits, which are determined by the arrangement of the guide device relative to the respective guide body. Torsional moments which act on the support means are in a given case introduced by way of the guide body into the guide device and so compensated by the interaction between the guide body and the guide device that the amount of a rotation or twisting of the support means about the longitudinal direction thereof remains within the predetermined limits.

The support means according to the present invention has various advantages, particularly with respect to applications in elevators:

The present invention offers the possibility of optimizing the trunk of the support means or the guide surfaces of the trunk on the one hand and the guide body or the guide device for the guide body on the other hand respectively independently of one another. For guidance of the trunk there are suitable, for example, guide surfaces which by virtue of their construction do not prevent rotation of the trunk about the longitudinal direction thereof if a torsional moment acts on the trunk. The trunk and the guide surfaces for the trunk can, for example, be so selectively matched to one another that guidance of the trunk transversely to the longitudinal direction thereof is optimized, for example with respect to the stability of the guidance or specific wear phenomena. In the case of this optimization it can be secondary whether the guide surfaces for the trunk do or do not permit rotations of the trunk about its longitudinal direction. According to the invention rotations or twistings of the trunk about the longitudinal direction thereof are limited or prevented, without further measures, with the help of the guide body and a guide device for the guide body.

The guide bodies for the support means can be realized by technologies which have already proven themselves in the manufacture of conventional support means. Moreover, support means according to the present invention are compatible with components used in conventional elevator installations for guiding or driving conventional support means. The support means can be guided, for example, by a drive pulley and/or by rollers transversely to its longitudinal direction. A respective guide surface for the trunk of the support means can be formed at the periphery of the drive pulley or at the respective roller, for example in the form of a guide groove. Existing elevator installations can accordingly also be equipped with support means according to the invention. Retrofitting is possible with little expenditure.

For the construction of the trunk of the support means concepts can, for example, be advantageously used which have proven themselves in cables. The trunk can be constructed as a conventional cable and have, for example, a cross-section with a round profile, for example with a circularly round profile (i.e. with a ratio of width “A” to height “B” equal to “1”). The trunk can moreover comprise a single strand, which comprises several tensile carriers twisted together, with a cross-section with a similarly round, for example circularly round, profile. A trunk shaped in that manner can, for example, in the case of a movement in its longitudinal direction be guided in guide grooves with a half-round profile transversely to the longitudinal direction of the trunk with a high degree of stability, low abrasion and low development of noise. These advantages are opposed by the fact that a trunk of that kind, due to its shape, is guided in a guide groove with a half-round profile in such a manner that it is rotatable about its longitudinal direction if no additional measures are undertaken. Rotations of the trunk can be kept within predetermined limits in that the trunk according to the present invention is provided with a guide body and a guide device for the guide body is made available.

The present invention is not specifically confined to support means with a trunk with a round or circularly round cross-section. On the basis of the present invention it is possible to preferably protect support means, the trunk of which has a cross-section with a width “A” and a height “B” with a ratio A/B of “0.5” to “2”, against twistings. By “width A” and “height B” there shall be understood in this connection the maximum extents of a cross-section of the trunk in each of two predetermined orthogonal directions. Obviously, also a support means with a trunk in which one of the magnitudes “A” or “B” is greater by more than a factor “2” than the respective other magnitude (A/B <0.5 or A/B >2) can be equipped with a guide body according to the present invention. In the latter case the trunk can usually be guided (in shape-locking manner) in a guide groove, which is matched to the cross-sectional shape of the trunk, in such a way that rotation of the trunk about its longitudinal direction within the guide groove is hardly possible due to the shape of the trunk (without damaging the support means). In the latter case there is no advantage if the trunk is equipped with a guide body according to the present invention.

In one form of embodiment of the support means the trunk of the support means can also comprise more than one strand consisting of several tensile carriers twisted or braided together. The guide body can be directly fastened to a strand or in a given case to several strands.

Alternatively, the surface of the respective trunk can be formed by a casing which encloses the respective strands. In this case the respective guide body can be fastened to the casing. In a variant of this concept it is provided that the casing and the guide body are of integral construction. This variant is advantageous with respect to manufacture. The casing and the respective guide body can be produced from, for example, the same material and, in particular, in common in a single production step. For production of the casing and the respective guide body, for example, materials and methods are suitable which have already proved themselves in the manufacture of casings for conventional cables. As material for the respective guide body or the casing there are suitable, for example, synthetic materials, polymers, elastomers or thermoplastic materials. The guide body and/or the casing can also be provided in each instance with at least one reinforcing element for mechanical reinforcement of the guide body. It can be achieved by the latter measures that the mechanical stability of the respective guide body or the respective casing is improved and/or the wear strength of the guide body and/or of the casing is improved.

A further form of embodiment of the support means comprises two guide bodies which extend in the longitudinal direction of the support means, protrude laterally from the trunk and are arranged in such a manner that at a surface of the trunk they are separated by an intermediate space and/or are arranged at opposite sides of the support means. In this case there is formed at the surface of the trunk between the two guide bodies a strip-shaped region which extends in the longitudinal direction of the guide body. This region of the trunk can be brought into contact with a guide surface for the trunk so as to guide the support means transversely to the longitudinal direction thereof. According to the present invention for each guide body there can be provided a respective guide device for limiting or preventing rotation of the support means about its longitudinal axis. This configuration has the advantage that rotations of the support means not only in one rotational direction, but also in the opposite rotational direction can be limited or prevented by simple means.

A guide device for the respective guide body can be realized, according to the present invention, in several variants.

According to one variant the guide device for the respective guide body comprises a mechanical abutment. The mechanical abutment is arranged at the support means in such a manner that rotation of the support means about its longitudinal direction in a predetermined rotational direction is limited or prevented at least in a region of a longitudinal section of the support means by a mechanical contact between the abutment and the guide body.

According to a further variant the guide device comprises for the respective guide body two mechanical abutments. The two mechanical abutments are arranged in such a manner with respect to the guide body that the guide body is guided between the two mechanical abutments and a rotation of a support means about its longitudinal direction is limited or prevented in a first rotational direction at least in the region of a longitudinal section of the support means by a mechanical contact between guide body and one of the abutments and a rotation of the support means about its longitudinal direction in the rotational direction opposite to the first rotational direction is limited or prevented at least in the region of a longitudinal section of the support means by a mechanical contact between the guide body and the other one of the abutments.

According to a further variant not only the guide surface for the trunk of the support means, but also the guide device for the respective guide body are arranged at the periphery of a roller. The term “roller” shall obviously also stand, in the context of the invention, for the terms “drive pulley” or “pulley”.

The guide surface for the trunk can, for example, be formed in a guide groove at the periphery of the roller. The respective guide body can be so arranged at the trunk of the support means that the guide body is accessible from the periphery, particularly when the support means is moved in the longitudinal direction. In this manner it is possible to guide the guide body by simple means. The guide device for the guide body can, for example, be arranged near the guide surface for the trunk at the periphery of the roller.

The guide groove can, for example, be so shaped that the trunk partly projects out of the guide groove. In this manner the respective guide body is particularly easily accessible from the periphery of the roller. The respective guide body can, for example, be so arranged at the trunk of the support means that it similarly projects out of the guide groove. The drive body can, for example, be so arranged at the trunk of the support means that it laterally protrudes beyond one of the edges of the guide groove. In this case the roller can be so constructed that a region of the surface of the roller near the guide groove serves as a guide device for the guide bodies: this region serves as a mechanical abutment for the guide body and limits or prevents rotation of the support means through a mechanical contact with the guide body. This variant has various advantages. On the one hand, it represents a simple realization of the guide device according to the present invention. It can, for example, be realized by conventional rollers on the assumption that near a guide surface (guide groove) for the trunk of the support means there is present, at the surface, a surface which either is disposed in contact with the support body or, in the case of rotation of the support means about its longitudinal direction, comes into contact. The shape of the cross-section of the support means merely has to be adapted in correspondence with the shape of a guide surface (guide groove). Moreover—depending on the kind of guidance of the trunk at the roller—the trunk can be guided at the guide surface in such a manner that a torsional moment is introduced into the trunk at the guide surface when the support means is moved in its longitudinal direction. The latter is the case, for example, when a section of the support means is moved at the guide surface in a direction which acts not parallel—but “oblique” —to the tension force acting on the section (if, for example, the tension force acting on the section is not oriented perpendicularly to the rotational axis of the roller). In the present case the guide device for the guide body acts directly at the roller on the support means. Accordingly, compensation can even be provided directly at the roller for torsional moments which in a given case are introduced at the roller (by way of the trunk) into the support means. In this manner, twistings of the support means can be limited or prevented particularly efficiently, particularly twistings of those sections of the support means in which the support means is not guided (for example in a section between two rollers or in a section between a roller and an end fastening for one of the ends of the support means).

In a further variant the guide surface for the trunk of the support means and the guide device for the guide body are constructed in such a manner that the trunk and the guide body are guided in shape-locking manner in each instance on two opposite sides. In this manner movements of the trunk transversely to the longitudinal direction are limited or prevented in any direction and rotational movements of the trunk with any rotational sense. For this purpose the trunk of the support means and the guide body can, for example, be guided in shape-locking manner between two rollers. Alternatively, the trunk of the support means and the guide body can be guided in shape-locking manner by a guide channel (in a given case with some play).

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic elevation view of an elevator for transporting an elevator car and a counterweight by movable support means according to the present invention;

FIG. 2a is a fragmentary perspective view and FIG. 2b is a cross-sectional end view of one of the support means according to FIG. 1 with guide bodies according to the present invention;

FIG. 3a is a perspective view and FIG. 3b is a side elevation view of support means according to FIG. 2 with guide devices for the respective guide bodies;

FIGS. 4a and 4b are views similar to FIGS. 3a and 3b respectively with a variant of the guide devices for the respective guide bodies; and

FIGS. 5a and 5b are views similar to FIGS. 3a and 3b respectively with a further variant of the guide devices for the respective guide body.

### DESCRIPTION OF THE PREFERRED EMBODIMENT

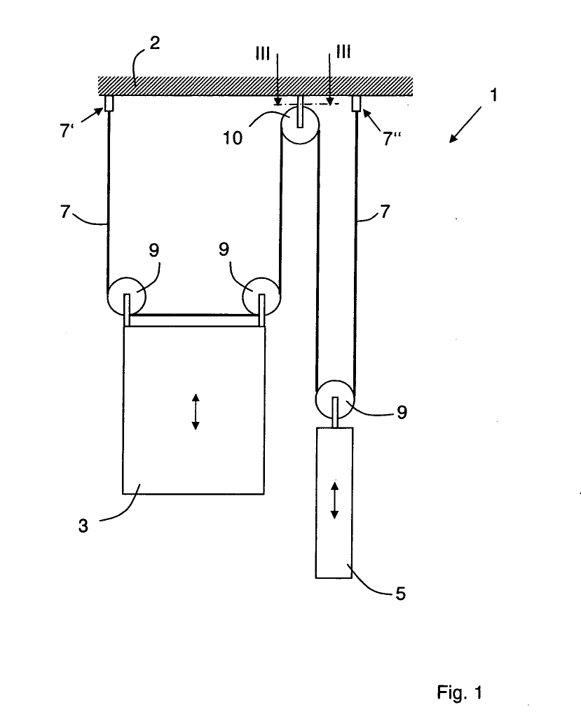

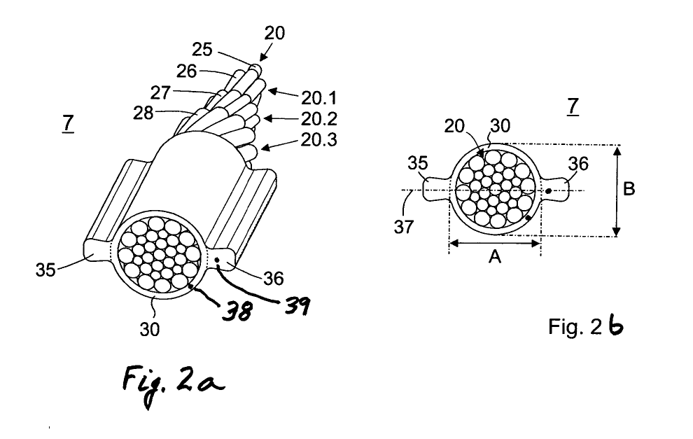

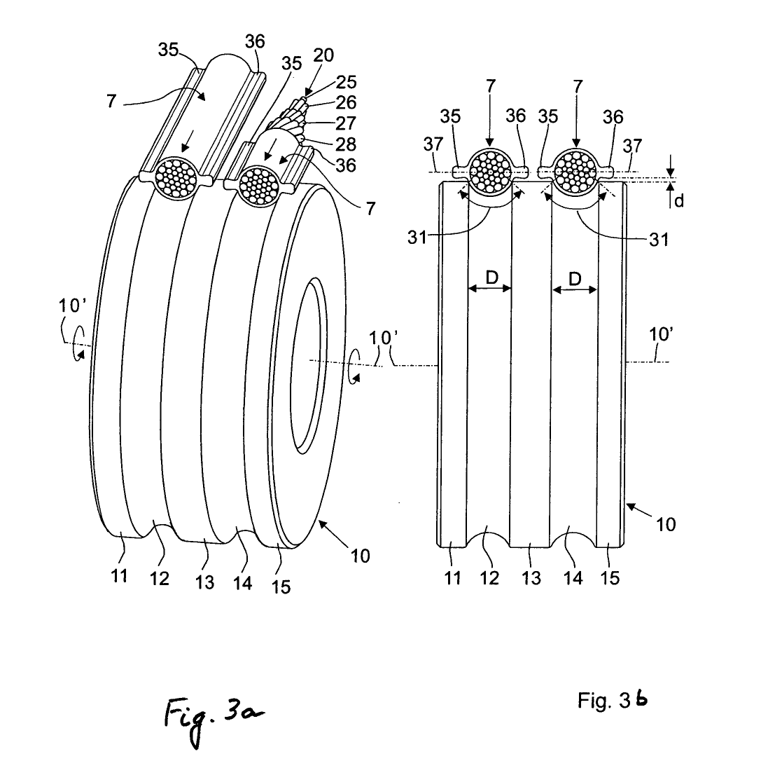

FIG. 1 shows an elevator 1 for transporting at least one load with at least one movable support means 7, which support means is connected with the load, according to the present invention. FIGS. 2a, 2b, 3a and 3b illustrate further details of the support means 7 and associated guide bodies.

The elevator 1 in the present case comprises two loads transportable by two support means 7: an elevator car 3 and a counterweight 5. Each support means 7 has two ends which are fastened by two end fastenings 7′ and 7″ to a support structure 2.

The support means 7 is guided by way of a rotatably mounted drive pulley 10, which is arranged at the support structure 2 together with a drive (not illustrated) for rotating the drive pulley 10. The support means 7 is guided in the region of the longitudinal section, which extends between the drive pulley 10 and the end fastening 7′, additionally around two deflecting rollers 9 which are both fastened to the car 3. In that case a 2:1 suspension for the car 3 is realized. The support means 7 is guided in the region of the longitudinal section, which extends between the drive pulley 20 and the end fastening 7″, additionally around a deflecting roller 9 which is fastened to the counterweight 5. A 2:1 suspension for the counterweight 5 is thereby realized. If the drive pulley 10 is set in rotation about the rotational axis thereof traction forces are transmitted to the support means 7 and the support means 7 is moved in its longitudinal direction. This has the effect that the support means 7 runs around the deflecting rollers 9 and at the same time the elevator car 3 and the counterweight 7 are moved upwardly and downwardly respectively in opposite sense depending on the respective rotational direction of the drive pulley 10, as is indicated in FIG. 1 by a respective double arrow at the car 3 and at the counterweight 5.

In the case of travel of the car 3, the drive pulley 10 and the deflecting rollers 9 influence the track which the support means 7 follow during movement thereof in their longitudinal direction. The regions at the peripheries of the rollers 9 and 10, which come into contact with the respective support means 7 during travel of the car 3, in that case form a guide for the support means 7.

FIGS. 2a and 2b show a longitudinal section of the support means 7 in perspective and elevation: in FIG. 2b there is illustrated a cross-section of the support means 7, whilst FIG. 2a shows the longitudinal section in perspective, considered obliquely from above.

The support means 7 comprises: (i) a trunk consisting of a strand 20, which is formed from several tensile carriers, and a casing 30 enclosing the strand 20, and (ii) two guide bodies 35 and 36 which are respectively fixedly connected with the casing 30, extend in the longitudinal direction of the support means 7 and protrude laterally from the trunk.

The strand 20 comprises: a central tensile carrier 25; several tensile carriers 26 which are laid in a first layer 20.1 about the tensile carrier 25; several tensile carriers 27 which are laid in a second layer 20.2 about the layer 20.1; and several tensile carriers 28 which are laid in a third layer 20.3 about the layer 20.2. In the present case the layers 20.1, 20.2 and 20.3 are respectively arranged concentrically about the tensile carrier 25.

The tensile carriers 25, 26, 27 and 28 can in each instance be a wire or a strand of wires, natural fibers and/or fibers of a synthetic material, for example aramide. The strand 20 is thus constructed as a conventional cable. The tensile carriers 25, 26, 27 and 28 can be so twisted together that the strand 20 under a tension load is not free of rotation.

The casing 30 is of hose-like construction and at the inner side in contact with the tensile carriers 28 of the layer 20.3. The wall thickness of the casing 30 is constant along the profile of the strand (within the scope of usual production tolerances). The trunk of the support means 7 accordingly has a cross-section with a substantially circularly round profile and a width A and a height B in the ratio A/B=1 (see FIG. 2b). The latter is at least the case when the support means is unloaded. Due to the tension forces acting on the support means the support means 7 can be pressed in such a manner against the surfaces of the rollers 9 or the drive pulley 10 that the cross-section of the trunk is deformed at least in individual longitudinal sections of the support means 7 and adopts a shape departing from a circle.

The two drive bodies 35 and 36 respectively have the shape of a block and are arranged parallel to the tensile carrier 25 and in mirror image on opposite sides of the support means 7. The guide bodies 35 and 36 moreover lie on a common main axis 37 (FIGS. 2b and 3b), wherein a cross-section through the casing 30 and the guide bodies 35 and 36 is symmetrical with respect to the main axis 37. The latter has the advantage that the support means 7 can be guided on both sides of the main axis 37 in each instance by the same means.

The guide bodies 35 and 36 and the casing 30 can be made from, for example, a synthetic material, from polymers, elastomers or thermoplastic materials, such as, for example, polyurethane, from natural or synthetic rubber or silicon rubber. It is possible to make the guide bodies 35 and 36 and the casing 30 from the same material and produce them integrally. The casing 30 and the bodies 35 and 36 can, for example, be applied in common to the strand 20 by means of extrusion of a suitable material (for example polyurethane) or vulcanization of a suitable material (for example rubber) with use of suitable shaping means (for example dies), which give the respectively intended shape not only to the casing 30, but also to the guide bodies 35 and 36. Alternatively, the casing 30 and the guide bodies 35 and 36 can be realized separately and subsequently connected together at seam locations, which are indicated in FIGS. 2a and 2b by dashed lines (for example—depending on the respective material—by gluing, melting, etc.).

FIGS. 3a and 3b show in detail how the support means 7 are guided at the drive pulley 10. The drive pulley 10 and the support means 7 are illustrated in two different views in order to clarify the physical relationships. The dot-dashed line in FIGS. 3a and 3b marks a rotational axis 10′ of the drive body 10. FIG. 3b shows the drive pulley 10 in a section III-III according to FIG. 1 in such a manner that the rotational axis 10′ lies in the plane of the drawing. Thereagainst, in the case of FIG. 3a the perspective of the viewer is selected so that the rotational axis 10′ lies obliquely with respect to the plane of the drawing. Of the support means 7 there is shown in each instance merely a longitudinal section, one end of which contacts the drive pulley 10 at the periphery and the other end of which is arranged in the intermediate space between the drive pulley 10 and the deflecting roller 9 arranged at the counterweight 5. The remaining parts of the support means are not illustrated, so as to make the periphery of the drive pulley 10 visible in detail.

In FIGS. 3a and 3b the drive pulley 10 is illustrated in the state of rotation about the rotational axis 10′. The rotational direction of the rotation is characterized in FIG. 3a by arrows, which surround the axis of rotation 10′ in the form of circular segments. The tension means 7 in this situation are moved—corresponding with the direction of rotation of the drive pulley 10—in their longitudinal direction (in FIG. 3a the casing 30 of the support means 7 is provided each time with an arrow which indicates the direction of the movement of the respective support means). FIG. 3a accordingly shows in each instance a longitudinal section of the respective support means 7 when running onto the drive pulley 10.

The surface of the drive pulley 10 is divided up (at the periphery of the drive pulley 10) into five different regions arranged in succession in the direction of the rotational axis 10′:

into segments 11, 13 and 15 which have the shape of the circumferential surfaces of cylinders respectively of the same diameter and which are arranged rotationally symmetrically with respect to the rotational axis 10′;

a guide groove 12 which is arranged between the segments 11 and 13 and at its edges steplessly adjoins the segments 11 and 13, and

a guide groove 14 which is arranged between the segments 13 and 15 and at its edges steplessly adjoins the segments 13 and 15.

The guide grooves 12 and 14 are arranged parallel to one another and rotationally symmetrically with respect to the rotational axis 10′. The guide grooves 12 and 14 are identical with respect to their shape and have, in particular, the same width D.

As shown in FIGS. 3a and 3b, each support means 7 is so arranged that the trunk of the respective support means runs into one of the guide grooves 12 and 14 in each instance tangentially to the base of the respective guide groove 12 or 14 and substantially perpendicularly to the rotational axis 10′.

The guide grooves 12 and 14 each form a respective guide surface for the trunk of one of the support means 7 and are so constructed that the respective support means 7 is guided transversely to its longitudinal direction. For this purpose the shape of the cross-section of the guide groove 12 or 14 is adapted as follows to the shape of a cross-section of the respective support means 7:

The guide bodies 35 and 36 of the support means 7 are so dimensioned that they are separated at the outer surface of the trunk of the support means 7 by intermediate spaces and bound, in one of these intermediate spaces, a strip-shaped region 31, which extends in the longitudinal direction of the support means 7, of the surface of the trunk. The region 31 is—in a cross-section—convexly curved and has a width which is greater than or equal to the width D of the guide groove 11. Moreover, the guide groove 12 or 14 is so shaped in a cross-section that the respective region 31 along the profile of the cross-section can be brought into contact with the surface of the guide groove 12 or 14. Due to the tension forces which the elevator car 3 and the counterweight 5 generate in the support means 7 the support means 7 is drawn into the guide groove 12 or 14 and pressed against the base and the flanks of the guide groove 12 or 14. The region 31 can thus be guided between the edges of guide groove 12 or 14. In this manner the trunk of the respective support means 7 is guided in the guide groove 12 or 14 in the case of circulation about the drive pulley 10 and thus guided, in the case of a movement in its longitudinal direction, in each instance transversely to its longitudinal direction.

As FIGS. 3a and 3b show, the width A and the height B of the trunk of the support means 7 are so selected that a longitudinal section of the support means 7, which is guided in the guide groove 12 or 14, protrudes in radial direction with respect to the rotational axis 10′ out of the guide groove 12 or 14. In particular, the guide bodies 35 and 36 protrude in the region of such a longitudinal section in the direction of the rotational axis 10′ beyond the respective edges of the guide groove 12 or 14 in such a manner that the guide bodies 35 and 36 in the case of circulation of the respective support means 7 around the drive pulley 10 at the periphery of the drive pulley 10 are guided in the region of one of the segments 11, 13 and 15. The guide bodies 35 and 36 are guided with respect to the segments 11, 13 and 15 preferably with a degree of play (greater than zero millimeters, preferably 0.1 millimeters or more), as is indicated in FIG. 3b at d. The guide bodies 35 and 36 therefore do not necessarily have to be guided around the support means 7 transversely to the longitudinal direction thereof.

In the present case each guide groove 12 and 14 (just as the trunk of the support means 7 in the region 31) has a cross-section in the shape of a segment of a circle. If the support means were not equipped with the guide bodies 35 and 36, then the trunk of the support means 7 due to its round shape could be rotated or twisted in the guide groove 12 or 14 when a torsional moment acts on the support means 7.

In FIG. 3b the support means 7 are each shown in a setting in which the principal axes 37 are directed parallel to the rotational axis 10′ of the drive pulley. In this setting the guide bodies 35 and 36 each have the predetermined spacing d relative to the surface of the drive body 10. The size of the spacing d determines to which extent the support means 7 can be rotated about the longitudinal direction thereof.

In the case of the support means 7 of which the trunk is guided in the guide groove 12, the segment 11 forms a mechanical abutment for the guide body 35 and the segment 13 a mechanical abutment for the guide body 36: if the support means 7 rotates in the guide groove 12 about its longitudinal direction (for example, in the case of action of the torsional moment), then—depending on the rotational direction of the rotation—either the guide body 35 is pressed against the segment 11 and the rotation of the support means 7 is thus limited or prevented (in a first rotational direction) or the guide body 36 is pressed against the segment 13 and the rotation of the support means is thus limited or prevented (in a rotational direction opposite to the first rotational direction). Through an interaction of the guide body 35 with the segment 11 (in the case of a rotation in the first rotational direction) or through an interaction of the guide body 36 with the segment 13 (in the case of a rotation in the rotational direction opposite to the first rotational direction) it is possible to provide compensation for torsional moments acting on the support means. The segment 11 accordingly represents a guide device for the guide body and has the function of limiting or preventing rotation of the support means 7 in the guide groove 12 in the first rotational direction. Correspondingly, the segment 13 represents a guide device for the guide body 36 and has the function of limiting or preventing a rotation of the support means 7 in the guide groove 12 in the rotational direction opposite to the first rotational direction.

The aforesaid explanations are analogously usable for the support means 7 which is guided in the guide groove 14. In the case of this support means 7 the segment 13 represents a mechanical abutment and thus a guide device for the guide body 35 and has the function of limiting or preventing rotation of the support means 7 in the guide groove 14 in a first rotational direction. Moreover, the segment 15 represents a mechanical abutment and thus a guide device for the guide body 36 and has the function of limiting or preventing a rotation of the support means 7 in the guide groove 14 in the rotational direction opposite to the first rotational direction.

The deflecting rollers 9 have, at their periphery, structures which structurally and functionally correspond with the guide grooves 12 and 14 and the segments 11, 13 and in order to guide the trunk and the guide bodies 35 and 36 of the respective support means 7 on circulation around the deflecting rollers 9 in the same manner as at the periphery of the drive pulley 10. Correspondingly, the support means 7 are so guided that the deflecting rollers 9 that rotations of the support means 7 at the deflecting rollers 9 are limited or prevented just as at the drive pulley 10. In this manner, twistings of the support means 7 are prevented on the entire length of the respective support means 7 or the amount of twistings is kept within limits on the entire length of the respective support means 7.

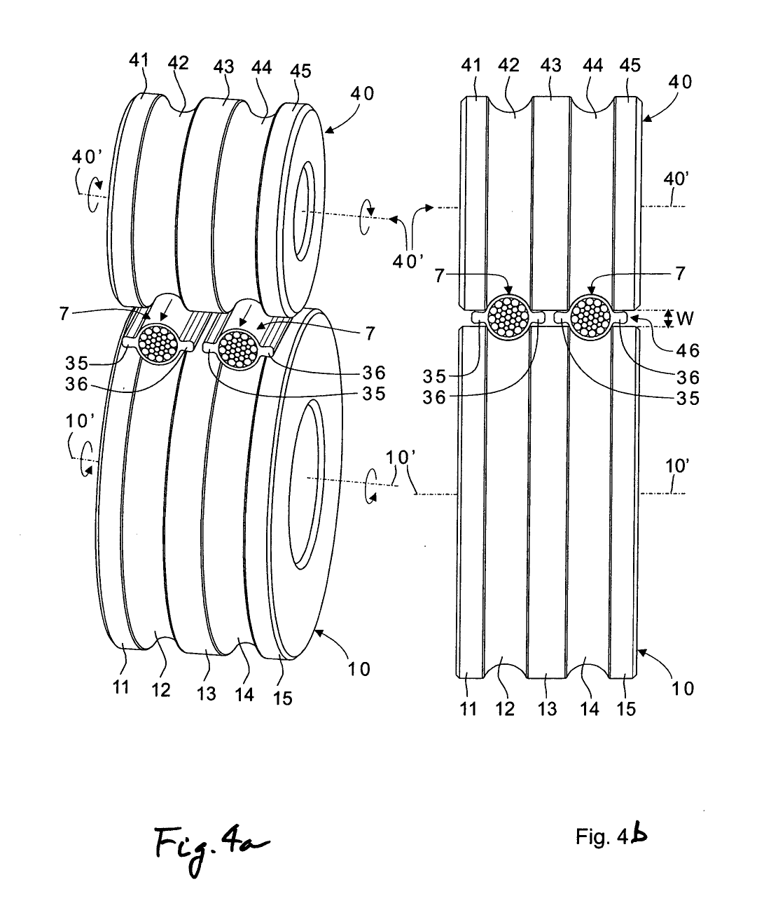

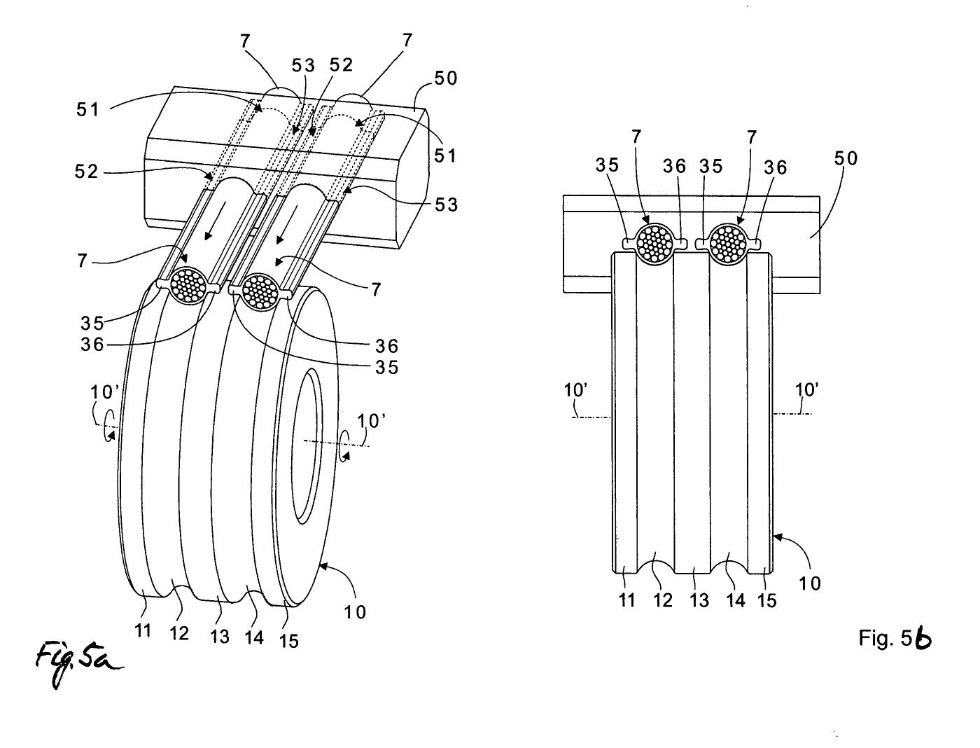

FIGS. 1 to 3b show examples of a first embodiment in which each support means 7 or the trunk and the guide bodies of the support means 7 are merely guided at one side. FIGS. 4a to 5b show further developments which allow guidance at two sides.

The further development according to FIGS. 4a and 4b is based on a modification of the arrangement illustrated in FIGS. 3a and 3b. Two support means 7 which are arranged parallel and movable in their longitudinal direction are guided, in the case of movement in their longitudinal direction, between two rollers: the support means 7 are guided each time at one side (as in the arrangement according to FIGS. 3a and 3b) at the periphery of the drive pulley 10 and at the respective other side at the periphery of a roller 40. The roller 40 is in that case so arranged that a rotational axis 40′ thereof is aligned parallel to the axis of rotation 10′ of the drive pulley 10 and that present between the drive pulley 10 and the roller 40 is an intermediate space 46 which has at its narrowest point a (minimal) width W (>0).

FIGS. 4a and 4b shows an arrangement of the drive pulley 10, the roller 40 and the support means 7 from two different perspectives: the arrangement is illustrated in FIG. 4b in side elevation so that the rotational axes 10′ and 40′ are oriented parallel to the plane of the drawing, and in FIG. 4a in perspective such that the rotational axes 10′ and 40′ are aligned obliquely to the plane of the drawing.

The drive pulley 10 and the roller 40 are each time illustrated in the state of a rotation, wherein the rotational direction of the respective rotation in FIG. 4a is characterized by arrows which surround the rotational axis 10′ or the rotational axis 40′ in the form of segments of circles. Correspondingly, the support means 7 are illustrated in the state of a movement, which is synchronous with the rotation of the drive pulley 10 and the rotation of the roller 40, in their longitudinal direction. Of each of the support means 7 there is shown each time a (rectilinearly extending) longitudinal section which runs off tangentially from the periphery of the drive pulley 10 and tangentially from the periphery of the roller 40 and is arranged perpendicularly to the axes of rotation 10′ and 40′, wherein the direction of movement of the respective longitudinal section in FIG. 4a is indicated by an arrow directed parallel to the longitudinal direction of the support means 7.

As FIG. 4 shows, the roller 40 has in a radial section at the periphery a profile which is identical with the corresponding profile of the drive pulley 10. Correspondingly, the surface of the roller 40 at the periphery is divided into five different regions arranged in succession in the direction of the rotational axis 40′:

into segments 41, 43 and 45, which have the form of the circumferential surface of cylinders each of the same diameter and are arranged rotationally symmetrically with respect to the rotational axis 40′;

a guide groove 42 which is arranged between the segments 41 and 43 and at its edges steplessly adjoins the segments 41 and 43; and

a guide groove 44 which is arranged between the segments 43 and 45 and at its edges steplessly adjoins the segments 43 and 45.

Moreover, the segment 41 has (each time in the direction of the rotational axis 40′) the same width as the segment 11, the segment 43 has the same width as the segment 13 and the segment 45 has the same width as the segment 15. Moreover, the guide grooves 12, 14, 42 and 44 each have in cross-section the same profile corresponding with the cross-sectional shape of the trunk of the support means 7.

According to FIG. 4b, each one of the support means 7 is so arranged and the width W so selected that:

one side of the trunk of the support means 7 is guided transversely to the longitudinal direction thereof in shape-locking manner (in a given case without play) in the guide groove 12, whilst the other side of the trunk is guided transversely to the longitudinal direction of the support means 7 in shape-locking manner (in a given case without play) in the guide groove 42;

the guide element 35 of this support means 7 is guided (with some degree of play) on the side, which faces the drive pulley 10, in shape-locking manner with respect to the segment 11 and is guided (with some degree of play) on the side, which faces the roller 40, in shape-locking manner with respect to the segment 41; and

the guide element 36 of this support means 7 is guided in the intermediate space 46 (with some degree of play) on the side, which faces the drive pulley 10, in shape-locking manner with respect to the segment 13 and is guided (with some degree of play) on the side, which faces the roller 40, in shape-locking manner with respect to the segment 43.

The guide grooves 12 and 42 thus form guide surfaces for the trunk of this support means 7 in order to guide the support means 7 transversely to the longitudinal direction thereof. The guide grooves 12 and 42 guide this trunk in shape-locking manner on two opposite sides and thus approximately along its entire circumference (apart from two strip-shaped regions with a respective width of approximately W in the vicinity of the guide elements 35 and 36). The trunk of this support means 7 accordingly cannot readily leave the guide grooves 12 and 42 transversely to the longitudinal direction of the trunk (i.e. not without damage). In this manner a particularly reliable guidance of the trunk transversely to the longitudinal direction thereof is guaranteed.

With respect to rotations of this support means 7 about the longitudinal direction the segments 11 and 41 each time form a mechanical abutment for the guide body 35 and the segments 13 and 43 a mechanical abutment for the guide body 36.

Rotations of this support means 7 about the longitudinal direction are restricted or prevented in that:

in the case of a rotation in a first rotational direction the guide body 35 hits against the segment 11 and the guide body 36 hits against the segment 43 and thus limit the rotation; and

in the case of a rotation in the opposite rotational direction the guide body 35 hits against the segment 41 and the guide body 36 hits against the segment 13 and thus limits the rotation.

In the case of this support means 7 the segments 11 and 41 thus form guide devices for the guide body 35 for limiting or preventing rotations of the support means 7 about the longitudinal direction in any rotational directions and correspondingly the segments 13 and 43 form guide devices for the guide body 36 for limiting or preventing rotations of the support means 7 about the longitudinal direction in any rotational directions.

Accordingly, the significant advantage of the arrangement according to FIGS. 4a and 4b is that a single one of the guide bodies 35 and 36 is already sufficient to restrict rotations in any rotational directions to a predetermined angular range. The angular range can be minimized by an appropriate predetermination of the width W. In the present case it is additionally advantageous that the guide bodies 35 and 36 are arranged in mirror image on opposite sides of the support means 7 or symmetrically with respect to the main axis 37 (FIGS. 2a, 2b, 3a and 3b). In the case of rotation of the support means 7 about its longitudinal direction in any rotational direction in each instance not only the guide body 35, but also the guide body 36 are pressed against a mechanical abutment. Torsional moments which in a given case can be introduced by way of the guide bodies 35 and 36 into the segments 11 and 43 or 13 and 41 usually act symmetrically with respect to the center of the trunk. Thereby, in a given case both guide bodies 35 and 36 are uniformly loaded. The latter improves the wear resistance of the support means 7.

The aforesaid considerations apply analogously to the other of the support means 7 according to FIGS. 4a and 4b, the trunk of which is guided each time in shape-locking manner on one side in the guide groove 14 of the drive pulley 10 and on the other side in the guide groove 44 of the roller 40. In the case of this support means 7 the segments 13 and 43 form guide devices for the guide body 35 for limiting or preventing rotations about the longitudinal direction in any rotational directions and correspondingly the segments 15 and 45 form guide devices for the guide body 36 for limiting or preventing rotations about the longitudinal direction in any rotational directions.

The further development according to FIGS. 5a and 5b is based on a modification of the arrangement illustrated in FIGS. 3a and 3b. Two support means 7 which are arranged in parallel and movable in the longitudinal direction thereof are—as in the arrangement according to FIGS. 3a and 3b—guided in the case of a movement in their longitudinal direction each time in one of the guide grooves 12 and 14 of the drive pulley 10. The further development according to FIGS. 5a and 5b is illustrated from two different directions: in side elevation in FIG. 5b so that the rotational axis 10′ of the drive pulley 10 is arranged parallel to the plane of the drawing and in perspective in FIG. 5a such that the rotational axis 10′ is oriented obliquely to the plane of the drawing.

As in FIG. 3a, the drive pulley 10 is illustrated in the state of rotation about the rotational axis 10′. The rotational direction of the rotation is characterized in FIG. 5a by arrows, which surround the rotational axis 10′ in the form of segments of circles. The traction means 7 are moved synchronously with the rotation of the drive pulley 10 in their longitudinal direction (in FIG. 5a the trunk of a respective support means 7 is provided with an arrow which indicates the direction of the movement). FIG. 5a accordingly shows each time a longitudinal section of the respective support means 7 on running into the corresponding guide groove 12 or 14. The remaining parts of the support means 7 are not illustrated.

At the guide pulley 10, the trunks of the support means 7 are guided transversely to the longitudinal direction thereof merely on one side. Correspondingly, the guide bodies 35 and 36 of the support means 7 are guided at the segments 11, 13 and 15 of the drive pulley 10 only on one side. In order to improve the stability of the guidance, according to FIGS. 5a and 5b a guide device 50 for the support means 7 is arranged in the vicinity of the drive pulley. The guide device 50 consists of a block, in which three guide channels 51, 52 and 53 are formed for each support means 7. The guide channels 51, 52, 53 have the following characteristics:

The guide channels 51, 52, 53 are arranged adjacent to one another and connected together at their sides.

The inner sides of the guide channels 51, 52 and 53 lie parallel to the longitudinal direction of the respective support means 7 and form guide surfaces for the trunk and the guide bodies 35 and 36 of the support means 7.

The trunk of the support means 7 is guided by the guide channel 51, the guide body 35 by the guide channel 52 and the guide body 36 by the guide channel 53.

The guide channel 51 is so shaped that the trunk of the support means 7 is guided transversely to its longitudinal direction on two opposite sides in shape-locking manner.

The guide channel 52 is so shaped that the guide body 35 is guided on two opposite sides in shape-locking manner.

The guide channel 53 is so shaped that the guide body 36 is guided on two opposite sides in shape-locking manner.

The trunk of the support means 7 cannot readily leave the guide channel 51 transversely to the longitudinal direction of the trunk (i.e. not without damage). The support means 7 is accordingly reliably guided in the guide channel 51 transversely to its longitudinal direction. Since the guide device 50 is arranged directly adjacent to the drive pulley 10, the support means 7 can in this manner be guided at the drive pulley 10 with a greater degree of stability.

With respect to rotations of this support means 7 about the longitudinal direction the inner sides of the guide channel 52 each time form mechanical abutments for the guide body 35 and the inner sides of the guide channel 53 each time form mechanical abutments for the guide body 36.

Rotations of this support means 7 about the longitudinal direction are restricted or prevented at the guide device 50 in that:

in the case of a rotation in a first rotational direction the guide body 35 hits against one of the inner sides of the guide channel 52 and the guide body 36 hits against one of the inner sides of the guide channel 53 and thus limit the rotation; and

in the case of a rotation in the opposite rotational direction the guide body 35 hits against another of the inner sides of the guide channel 52 and the guide body 36 hits against another of the inner sides of the guide channel 53 and thus limit the rotation.

Thus, the guide channel 52 forms a guide device for the guide body 35 for limiting or preventing rotations of the support means 7 about the longitudinal direction in any rotational directions and correspondingly the guide channel 53 forms a guide device for the guide body 36 for limiting or preventing rotations of the support means 7 about the longitudinal direction in any rotational direction.

An advantage of the arrangement according to FIGS. 5a and 5b is to be seen in that a single one of the guide bodies 35 and 36 is already sufficient in order to restrict rotations in any rotational directions to a predetermined angular range. The angular range is determined by the dimensions of the guide channels 52 and 53. In the present case it is additionally advantageous that the guide bodies 35 and 36 are arranged in mirror image on opposite sides of the support means 7 (FIGS. 2a, 2b, 3a and 3b). In the case of a rotation of the support means 7 about the longitudinal direction thereof in any rotational direction in each instance not only the guide body 35, but also the guide body 36 are pressed against a mechanical abutment. In a given case the two guide bodies 35 and 36 are thereby uniformly loaded. The latter improves the wear resistance of the support means 7.

In order to still further improve the wear resistance of the support means 7 the guide bodies 35 and 36 and/or the casing 30 can additionally be provided with one or more reinforcing elements for mechanical reinforcement. The reinforcing elements can consist of, for example, fibers which are suitable for structural reinforcements (for example aramide, polyester, glass or carbon fibers), or of woven or braided structures of such fibers. The reinforcing elements can, for example, be embedded in the guide bodies 35 and 36 and/or in the casing 30 or can be arranged at the surface of the guide bodies 35 and 36 and/or at the surface of the casing 30. For example, in FIG. 2a reinforcing element fiber 38 is embedded in the casing 30 and reinforcing element fiber 39 is embedded in the guide body 36.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A support apparatus having a trunk with at least one strand of several tensile carriers twisted or braided together, which trunk extends in a longitudinal direction of the support apparatus, comprising:
a trunk having a cross-sectional area with a width to height ratio in a range of 0.5 to 2; and
at least one guide body projecting laterally from said trunk and extending in the longitudinal direction of said trunk.

2. The apparatus according to claim 1 including two of said guide body projecting from said trunk in opposite directions.

3. The apparatus according to claim 1 wherein said trunk includes a casing surrounding the at least one strand.

4. The apparatus according to claim 3 wherein said at least one guide body is one of fastened to said casing and formed integral with said casing.

5. The apparatus according to claim 3 wherein at least one of said at least one guide body and said casing include at least one reinforcing element for mechanical reinforcement thereof.

6. The apparatus according to claim 1 wherein said trunk has at a surface adjacent said at least one guide body a strip-shaped region extending in the longitudinal direction of said trunk and being adapted for contact with a guide surface for said trunk so as to guide said trunk transversely to the longitudinal direction thereof.

7. The apparatus according to claim 6 wherein said surface of said trunk is convexly curved in cross-section in said strip-shaped region.

8. The apparatus according to claim I wherein the tensile carriers are one of a wire, a strand of wires, a strand of natural fibers and a strand of fibers of a synthetic material.

9. An elevator for transporting at least one load by at least one support means, the support means being connected with the load and movable in a longitudinal direction, comprising:
a support means adapted to be connected to the at least one load and having a trunk extending in the longitudinal direction with at least one laterally projecting guide body, said at least one guide body extending in the longitudinal direction;
a guide surface receiving said trunk and guiding the support means transversely to the longitudinal direction; and
a guide device cooperating with said at least one guide body for at least partially preventing rotation of the support means about the longitudinal direction.

10. The elevator according to claim 9 wherein said guide device is a mechanical abutment and a rotation of the support means is at least partially prevented by a mechanical contact between said abutment and said at least one guide body.

11. The elevator according to claim 9 wherein said guide device is two mechanical abutments and said at least one guide body is guided between said two mechanical abutments, a rotation of the support means in a first rotational direction being at least partially prevented by a mechanical contact between said at least one guide body and one of said abutments and in a rotational direction opposite to the first rotational direction is at least partially prevented by a mechanical contact between said at least one guide body and another one of said abutments.

12. The elevator according to claim 9 wherein the support means is guided around a roller and said guide surface is formed at a surface of the roller.

13. The elevator according to claim 12 wherein said guide surface is a groove formed at the surface of the roller.

14. The elevator according to claim 12, wherein said guide device is arranged at the roller adjacent to said guide surface.

15. The elevator according to claim 14 wherein said guide device is a region of the surface of the roller near said guide surface forming a mechanical abutment for contacting said at least one guide body.

16. The elevator according to claim 9 wherein said trunk of the support means is guided between two rollers and said guide device includes an abutment formed on each of said rollers.

17. The elevator according to claim 9 wherein said trunk of the support means and said at least one guide body are guided in a shape-locking manner between two rollers having formed therein said guide surface and said guide device.

18. The elevator according to claim 9 wherein said trunk of the support means and said at least one guide body are guided in a shape-locking manner through guide channels formed in said guide device.
